(19) United States
(12) Patent Application Publication
(10) Pub. No.: US 2021/0334476 A1
(43) Pub. Date: Oct. 28, 2021

(54) LANGUAGE-NEUTRAL TRANSLATION MEMORIES

(71) Applicant: Hewlett-Packard Development Company, L.P., Spring, TX (US)

(72) Inventor: Caroline Nan KOFF, Ft. Collins, CO (US)

(21) Appl. No.: 16/481,267

(22) PCT Filed: Jan. 25, 2018
(86) PCT No.: PCT/US2018/015273

§ 371 Date: Jul. 26, 2019

(51) Int. Cl. G06F 40/47

(52) U.S. Cl. CPC G06F 40/47

(57) ABSTRACT

In some examples, a system to receives language-neutral phrases of a source content, and stores the language-neutral phrases in a language-neutral translation memory useable to determine a language-neutral target text in a document being translated from a first language to a different second language. The receiving of the language-neutral phrases and the storing of the language-neutral phrases in the language-neutral translation memory are performed prior to a processing by a translation management system (TMS) that translates input text of documents between different languages using translation memories including the language-neutral translation memory.

### BACKGROUND

A document written in a first language (e.g., English) may be translated to documents in other languages for use by people who speak different languages. Examples of documents can include user manuals for products or services, technical specifications, published articles, instructions, books, and so forth. Translations of documents can be performed by human translators. The cost associated with translations can be proportional to the amount of time spent or number of words, phrases, or sentences translated by human translators in translating documents.

### BRIEF DESCRIPTION OF THE DRAWINGS

Some implementations of the present disclosure are described with respect to the following figures.

FIG. 1 is a block diagram of an arrangement that includes a language-neutral translation memory generator and a translation management or memory system (TMS), according to some examples.

FIGS. 2 and 3 are block diagrams of an arrangement that includes a TMS that uses a language-neutral translation memory according to some examples.

FIG. 4 is a flow diagram of a process according to some examples.

FIG. 5 is a block diagram of a storage medium storing machine-readable instructions according to further examples.

FIG. 6 is a block diagram of a system according to additional examples.

FIG. 7 is a flow diagram of a process according to other examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A translation memory can refer to a data structure containing translation information to translate input text in a first language (the “source language”) to a respective target text in a second language (the “target language”). An “input text” can refer to a word, a phrase, a sentence, a paragraph, or any other collection of words that can be found in a document. A “target text” can refer to a word, a phrase, a sentence, a paragraph, or any other collection of words produced after translation of the input text. A “document” can refer to any identifiable information container that includes text. A document can be written in a first language (e.g., English). The document is translated to a second language different from the first language for use by someone who understands the second language but not the first language.

Translation information stored in the translation memory can be based on previous translations that have been performed, such as by humans, machines, or programs. A translation memory stores source text and its corresponding translation (the target text) in pairs called “translation segments” (also known as “translation units”). A translation segment may include a word, a phrase, a sentence, a paragraph, or any other collection of words produced after the segmentation of input text. A translation memory includes multiple translation segments. During translation of a document, the translation information of the translation memory can be leveraged to assist in translating the document for any input text in the document that matches a translation segment in the translation memory. An input text “matching” a translation segment can refer to the input text partially or completely matching the translation segment.

There can be multiple translation memories for corresponding different language pairs. For example, a first translation memory can include translation segments that correlate input text in English to Spanish, a second translation memory can include translation segments that correlate input text in English to French, and so forth.

Translation memories can be used by a translation management system (TMS) (equivalently a translation memory system). The TMS can be implemented as machine-readable instructions executable in a computer system. For a given document to be translated from a first language to a second language, the TMS can search a translation memory associated with this language pair for translation segments that match input text of the given document. Any such matching segments from the translation memory can be output by the TMS, which can assist an entity (a human, a machine, or a program) in translating the given document between the first and second languages. The entity can decide to use a matching translation segment from the translation memory without modification in a translated version of the given document. Alternatively, the entity can decide to modify the matching translation segment from the translation memory for use in the translated version of the given document.

By being able to leverage the translations found in translation memories, less effort can be expended when translating a document, which improves efficiency in terms of usage of system resources (e.g., processing resources such as computer processors, storage resources such as computer memory or persistent storage, etc.) and/or human resources. More efficient use of resources in translating documents can lead to decreased translation costs and time. Also, by being able to leverage translation memories to perform translations, more accurate and consistent translations can be achieved since prior translations of input text can be used.

Certain words or phrases that appear in documents should not be translated between different languages. Such words or phrases can be construed as being “language-neutral.” In the present disclosure, the term “language-neutral phrase” can refer to a language-neutral word, a language-neutral phrase, a language-neutral sentence, or any other collection of words designated to be language-neutral. In an example, in the context of product manuals, product names and/or model numbers of products are typically not translated. In other examples, any other phrase in a document can be designated as a language-neutral phrase.

In further examples, a language-neutral phrase can also include a non-text portion of a document, such as an image, or metadata, such as text formatting constructs (e.g., <b>).

A language-neutral phrase is embedded in an input text (e.g., phrase, sentence, etc.) that is not language neutral. The input text is considered a translatable text that is to be processed by a TMS for translating the input text. In some cases, the input text includes a language-neutral phrase. Unless instructed otherwise, the TMS has to display the translatable text to the human translator even if the TMS embeds a language-neutral phrase that is not to be translated as part of a process of translating a document between different languages. This implies that the total word count that is to be translated is the sum of words that make up the language-neutral phrase and the translatable text. Increasing the total word count of text to be translated can increase the cost and time associated with performing a translation.

Since language-neutral phrases are not typically translated, they are unlikely to appear in traditional translation memories. As a result, when translating a document that includes language-neutral phrases, a TMS would indicate that there is no translation match of the language-neutral phrases in the translation memories consulted by the TMS. This would lead to increased effort (and cost) associated with reviewing the language-neutral phrases and deciding that the language-neutral phrases should not be translated.

In accordance with some implementations of the present disclosure, in addition to being able to use a standard translation memory (or multiple standard translation memories), a TMS is also able to use a language-neutral translation memory (or multiple language-neutral translation memories) when translating a document between different languages. A “standard” translation memory is a translation memory that includes multiple translation segments where each translation segment converts the input text from the first language to a second language that is different from the first language.

In contrast, a language-neutral translation memory includes translation segments containing language-neutral phrases that likely are not to be translated between the first and second languages. Note that although the language-neutral translation memory stores language-neutral phrases that are likely not to be translated, it is noted that the identified language-neutral phrases are not locked from being translated through the TMS—in other words, a translator can decide to translate a phrase that originated from the language-neutral translation memory.

A translation segment of the language-neutral translation memory includes a respective language-neutral phrase in the first language and a corresponding target text in the second language, where the corresponding target text in the second language is identical to the respective language-neutral phrase.

While different standard translation memories are provided for respective different language pairs (e.g., a first standard translation memory is provided for translation between English and Spanish, a second standard translation memory is provided for translation between English and French, etc.), a language-neutral translation memory is the same for all of the different language pairs. More generally, the language-neutral translation memory is common for a plurality of different language pairs.

However, note that there can be multiple language-neutral translation memories for respective different contexts, such as for different types of products. For example, for documents relating to calculators, the documents are likely to contain text that is specific to the calculators, such as math formulas. In the context of documents relating to calculators (a first context), language-neutral phrases would include such math formulas. Documents for other types of products (other contexts) would include other types of language-neutral phrases. As another example, for a context related to technology, the phrase “Apple” can refer to the company that manufactures consumer electronic devices. On the other hand, for a non-technological context, the term “apple” can refer to the fruit.

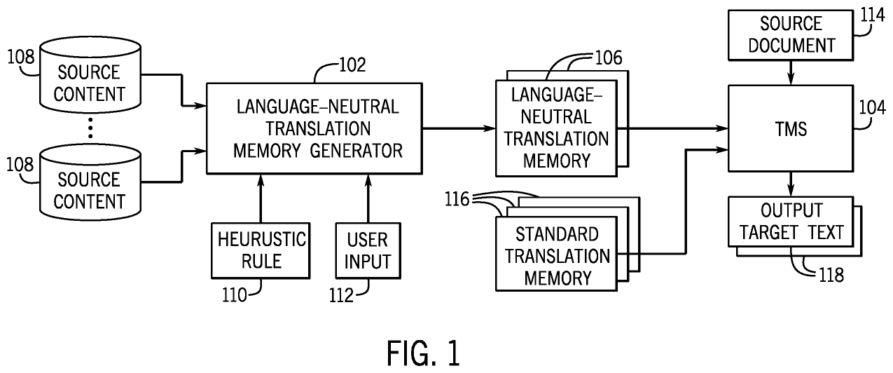

FIG. 1 is a block diagram of an example arrangement that includes a language-neutral translation memory generator 102 and a TMS 104 according to some examples. The language-neutral translation memory generator 102 and TMS 104 can be implemented as respective machine-readable instructions executable on a computer processor (or multiple computer processors). The language-neutral translation memory generator 102 and the TMS 104 can be implemented on the same computer platform or on separate computer platforms. A “computer platform” can refer to a computer or a combination of computers.

The language-neutral translation memory generator 102 can produce a language-neutral translation memory 106 (or alternatively, multiple language-neutral translation memories). The language-neutral translation memory generator 102 produces a language-neutral translation memory 106 based on a source content 108.

The source content 108 can include content extracted from a universe of documents. For example, an organization that provides products or services may produce user manuals, white papers, and so forth, for users to understand how to operate or use the products or services. The content of such user manuals, white papers, and so forth, can be provided as the source content 108 to the language-neutral translation memory generator 102.

In examples where the language-neutral translation memory generator 102 produces multiple language-neutral translation memories 106 for different contexts, the language-neutral translation memory generator 102 can process respective different source contents 108 for the different contexts. In other words, a first language-neutral translation memory 106 is produced from the source content 108 for a first context, a different second language-neutral translation memory 106 is produced from the source content 108 for a different second context, and so forth.

In some examples, the generation of a language-neutral translation memory 106 based on a source content 108 can be according to a heuristic rule 110. A heuristic rule specifies that a phrase in the source content having a specified characteristic is likely a language-neutral phrase. For example, the specified characteristic can be selected from among a number, a proper noun or identifier, an address, a graphic, or any other characteristic. More generally, a language-neutral phrase can be any phrase that is designated as language neutral. For example, a product name that includes a number and the name of the company (a proper noun) may be an example of a language-neutral phrase. Another example of a language-neutral phrase is a uniform resource locator (URL). As yet another example, a graphic including an image is usually not translated. In a further example, the heuristic rule 110 can indicate that a phrase matching a specific pattern is a language-neutral phrase. Although just one heuristic rule 110 is shown in FIG. 1, it is noted that the language-neutral translation memory generator 102 can use multiple heuristic rules 110 in other examples.

The language-neutral translation memory generator 102 can also receive a user input 112 from a human user to assist in producing the language-neutral translation memory 106. For example, the language-neutral translation memory generator 102 can present a specific phrase from a source content 108 to the human user, who can provide a designation of whether or not the specific phrase is a language-neutral phrase. Based on the user input 112, the language-neutral translation memory generator 102 can decide whether or not to add the phrase to a language-neutral translation memory 106.

The TMS 104 can use the language-neutral translation memory(ies) 106 generated by the language-neutral translation memory generator 102 when performing translations of input text of a source document 114. Although just one source document 114 is depicted in FIG. 1, it is noted that the TMS 104 can assist in translating multiple source documents.

In accordance with some implementations of the present disclosure, the language-neutral translation memory(ies) 106 are produced ahead of time (ahead of actual translation by the TMS 104) so that the TMS 104 can use the language-neutral translation memory(ies) 106 as part of a translation process.

In addition to using the language-neutral translation memory(ies) 106, the TMS 104 can also use a standard translation memory (or multiple standard translation memories) 116 to perform translations of input text of the source document 114. As noted above, a standard translation memory is a translation memory that includes multiple entries that convert between input text in a first language and corresponding translation segments in a second language. Each entry of a standard translation memory 116 includes a translation that was previously made.

The translation memories 106 and 116 can be stored on a storage device or multiple storage devices.

In the ensuing text, reference is made to the TMS 104 using a language-neutral translation memory 106 and a standard translation memory 116. It is noted that the discussion is also applicable to scenarios where the TMS 104 uses multiple language-neutral translation memories 106 and/or multiple standard translation memories 116.

The TMS 104 segments the input document 114. The segmentation is a parsing process where each paragraph, sentence, or phrase in the input document 114 is broken down into smaller chunks, or translatable units. The TMS 104 first generates source translation segments, and then searches the standard translation memory 116 for any translation segments that match the source translation segments. The TMS 104 also searches the language-neutral translation memory 106 for any translation segments that matches the source translation segment. Note that each language-neutral phrase can be embedded within a translatable text that is to be translated using the TMS 104.

Based on the matches to the standard translation memory 116 and the language-neutral translation memory 106, the TMS 104 can produce a list of prospective output target text 118 to a human translator (or multiple human translators).

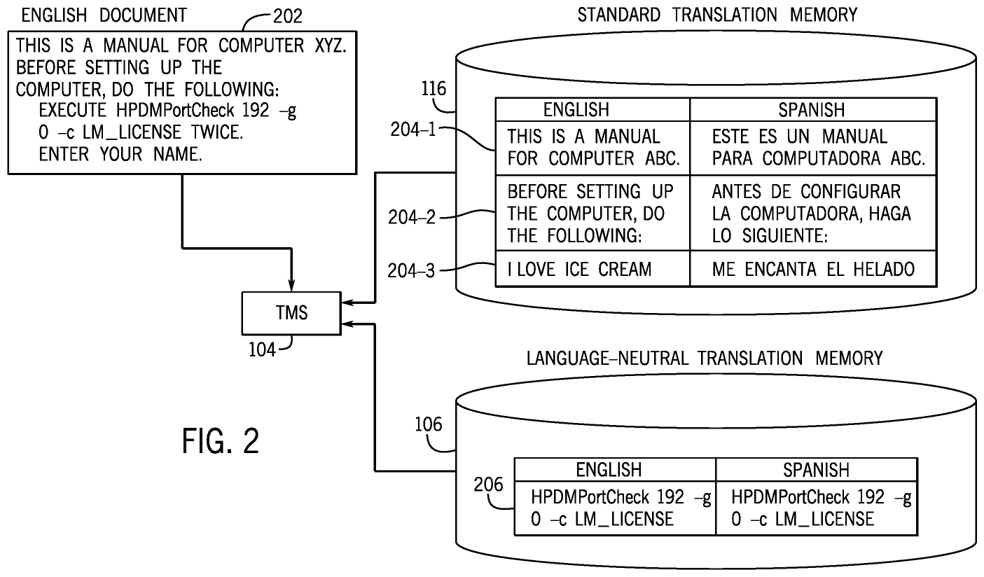

FIG. 2 shows an example of how the TMS 104 processes an input document 202 using the example language-neutral translation memory 106 and the example standard translation memory 116 shown in FIG. 2. The example standard translation memory 116 of FIG. 2 includes several translation segments 204-1, 204-2, and 204-3. Each translation segment 204-1, 204-2, or 204-3 of the standard translation memory 116 maps an input text in English to a target text in Spanish.

The example language-neutral translation memory 106 of FIG. 2 includes a translation segment 206 that maps a language-neutral phrase in English (“HPDMPortCheck 192-g 0 -c LM_LICENSE”) to a target text in Spanish (“HPDMPortCheck 192-g 0 -c LM_LICENSE”). Note that the language-neutral phrase in English is identical to the target text in Spanish in the translation segment 206 of the language-neutral translation memory 106.

Although FIG. 2 shows each of the language-neutral translation memory 106 and the standard translation memory 116 with a specific number of translation segments, it is noted that the translation memories can include different numbers of translation segments in other examples.

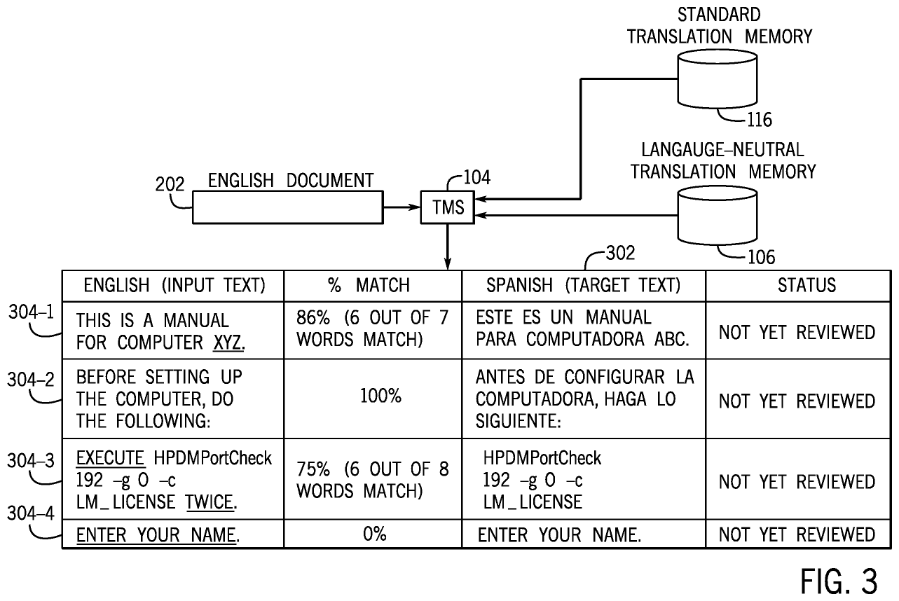

FIG. 3 shows an example of an output 302 produced by the TMS 104 based on processing the input document 202 using the standard translation memory 116 and the language-neutral translation memory 106. In the example of FIG. 3, the output 302 is in the form of a table that can be presented to a human translator, such as in a user interface displayed in a display device of a computer. The table includes multiple rows 304-1, 304-2, 304-3, and 304-4 and multiple columns. Each row corresponds to a translation pair (the input text in the source language and target text in the target language) that was generated by the TMS. A first column includes a translatable input text in English, the second column includes a value indicating a percentage match (by word count) by the TMS of the translatable input text to translation segments in the translation memories 106 and 116, the third column includes a target text in Spanish that was retrieved from a translation segment inside one of the translation memories, and the fourth column indicates whether the translation pair has been reviewed by a human translator.

In other examples, the output 302 can have other formats.

In the output 302, each word or phrase that is underlined (such as “XYZ” in the row 304-1, “Execute” and “twice” in row 304-3, and “Enter your name” in row 304-4) are the word or phrase that deviated from the translation segments found in the translation memories 106 and 116. In other examples, instead of underlining a non-matching text, the output 302 can indicate a non-matching text in a different way, such as by highlighting, assigning a different color, etc.

The input text “Execute HPDMPortCheck 192-g 0 -c LM_LICENSE twice” in row 304-3, first column, would result in a partial match against the phrase “HPDMPortCheck 192-g 0 -c LM_LICENSE” in row 304-3, third column, in the language-neutral translation memory 106. The “% match” (second column) in row 304-3 is 75% because six out of eight words matched between the text shown in the first column and the third column. If the language-neutral translation memory 106 was not present, the “% match” would have been 0%.

Thus, by using the language-neutral translation memory 106, when the TMS 104 generates a target text based on input text that embeds a language-neutral phrase that matches a translation segment in the language-neutral translation memory 106, the word count of the number of words that have to be translated is reduced. For example, if the language-neutral translation memory 106 were not used, then the word count of the number of words in row 304-3 to be translated would be eight (due to 0% match of the input text to translation memories). In contrast, if the language-neutral translation memory 106 is used and the language-neutral translation memory 106 includes a translation segment that matches the language-neutral phrase “HPDMPortCheck 192-g 0 -c LM_LICENSE,” then the word count of the number of words that have to be translated is reduced from eight to two (due to 75% match of the input text to a translation segment in the language-neutral translation memory 106).

A human translator can review the output 302 and can produce translated text based on the target text in the third column of the output 302. For the row 304-2 that contains the translation pair with 100% match, the human translator can simply accept the target text in row 304-2 as the translated text. For rows 304-1 and 304-3 with partial matches, the human translator can leverage portions of the target text and modify the remaining portions to produce the respective translated text. For row 304-4 with 0% match, the human translator can perform a translation of the entire input text.

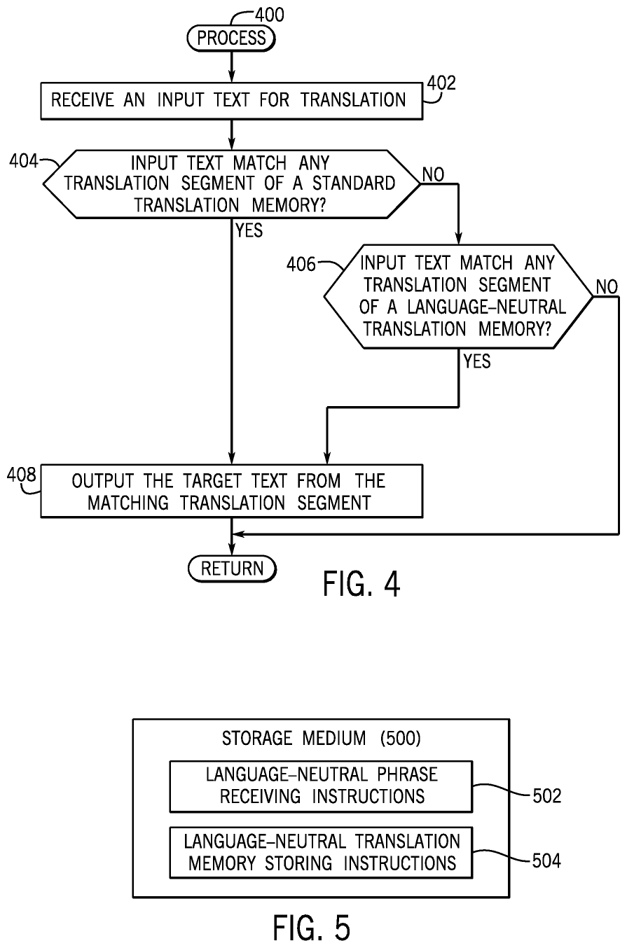

FIG. 4 is a flow diagram of a process 400 according to some examples. The process 400 can be performed by the TMS 104 according to some implementations of the present disclosure. The process 400 receives (at 402) an input text for translation. The received input text can be extracted from a source document, such as the source document 114 of FIG. 1 or 202 of FIG. 2. The process 400 performs a search of a standard translation memory (or multiple standard translation memories) to determine (at 404) if the input text matches any translation segment in a standard translation memory. As noted above, an input text matching a translation segment refers to the input text partially or completely matching the translation segment. If a match is found, the process 400 outputs (at 406) the target text from the matching translation segment of the standard translation memory.

However, if the input text does not match any translation segments of any standard translation memory, the process 400 searches a language-neutral translation memory (or multiple language-neutral translation memories) to determine (at 408) if the input text matches any translation segments in the language-neutral translation memory (or multiple language-neutral translation memories). If so, the process 400 outputs (at 406) the target text from the matching translation segment of the language-neutral translation memory. If the input text does not match any translation segments in the language-neutral translation memory (or multiple language-neutral translation memories), then the process 400 returns without outputting any target text from a translation memory.

FIG. 5 is a block diagram of a non-transitory machine-readable or computer-readable storage medium 500 storing machine-readable instructions that upon execution cause a system to perform various tasks. The machine-readable instructions include language-neutral phrase receiving instructions 502 to receive language-neutral phrases of a source content, and language-neutral translation memory storing instructions 504 to store the language-neutral phrases in a language-neutral translation memory useable to determine a language-neutral target text in a document being translated from a first language to a different second language. The receiving of the language-neutral phrases and the storing of the language-neutral phrases in the language-neutral translation memory are performed prior to any processing by a TMS that translates input text of documents between different languages using translation memories including the language-neutral translation memory.

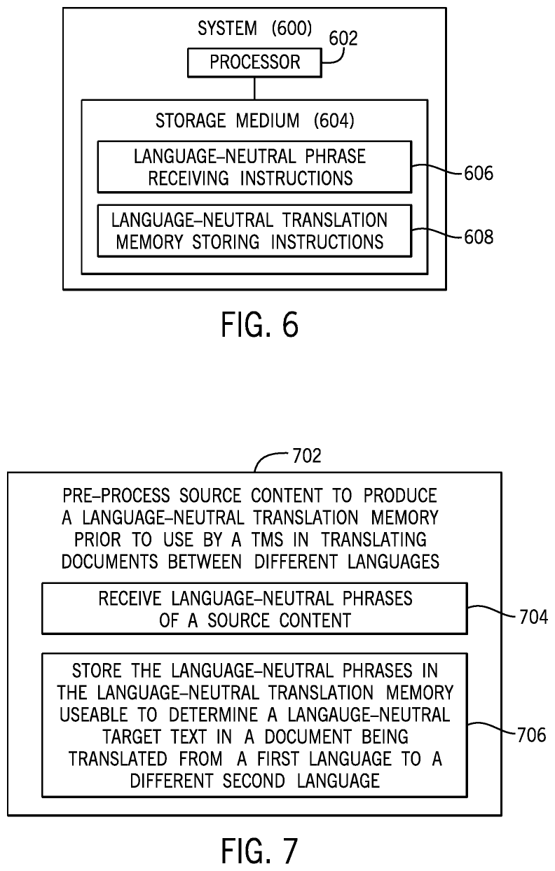

FIG. 6 is a block diagram of a system including a processor 602 and a non-transitory storage medium 604 storing machine readable instructions that are executable on the processor to 602 to perform various tasks. Machine readable instructions executable on a processor can refer to machine readable instructions executable on a single processor or on multiple processors. A processor can include a microprocessor, a core of a multi-core microprocessor, a microcontroller, a programmable integrated circuit, a programmable gate array, or another hardware processing circuit.

The machine readable instructions include language-neutral phrase receiving instructions 606 to receive language-neutral phrases of a source content, wherein each language-neutral phrase is a phrase that is likely not to be translated during translation between different languages. The machine readable instructions further include language-neutral translation memory storing instructions 608 to store the language-neutral phrases in a language-neutral translation memory useable to determine a language-neutral target text in a document being translated between the different languages. The machine readable instructions are executable to perform the receiving of the language-neutral phrases and the storing of the language-neutral phrases in the language-neutral translation memory prior to any processing by a TMS that translates input text of documents between the different languages using translation memories including the language-neutral translation memory.

FIG. 7 is a flow diagram of a process according to some examples. The process includes pre-processing (at 702), such as by the language-neutral translation memory generator 102 of FIG. 1, source content to produce a language-neutral translation memory prior for use by a TMS in translating documents between different languages. The pre-processing includes receiving (at 704) language-neutral phrases of a source content, and storing (at 706) the language-neutral phrases in the language-neutral translation memory useable to determine a language-neutral target text in a document being translated from a first language to a different second language.

The storage medium 500 (FIG. 5) or 604 (FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (such as a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
receive language-neutral phrases of a source content; and
store the language-neutral phrases in a language-neutral translation memory useable to determine a language-neutral target text in a document being translated from a first language to a different second language,
wherein the receiving of the language-neutral phrases and the storing of the language-neutral phrases in the language-neutral translation memory are performed prior to a processing by a translation management system (TMS) that translates input text of documents between different languages using translation memories including the language-neutral translation memory.

2. The non-transitory machine-readable storage medium of claim 1, wherein the language-neutral translation memory includes translation information that maps between the language-neutral phrases in the first language and corresponding target text in the second language.

3. The non-transitory machine-readable storage medium of claim 2, wherein the language-neutral translation memory includes a collection of translation segments, where each translation segment maps between a first language-neutral phrase in the first language and a corresponding first target text in the second language, the first language-neutral phrase in the first language and the corresponding first target text in the second language being identical.

4. The non-transitory machine-readable storage medium of claim 1, wherein the instructions upon execution cause the system to further:
receive a first document for translation;
in response to matching a given phrase of the first document to a first of the language-neutral phrases in the language-neutral translation memory, identify, by the TMS, a target text from the language-neutral translation memory and corresponding to the first language-neutral phrase for potential inclusion in a translated version of the first document.

5. The non-transitory machine-readable storage medium of claim 4, wherein the given phrase is embedded in translatable text of the first document, the instructions upon execution cause the system to further:
produce a target text for the translatable text using a standard translation memory.

6. The non-transitory machine-readable storage medium of claim 5, wherein the language-neutral translation memory is common for a plurality of different language pairs, and wherein the standard translation memory is specific to a particular language pair.

7. The non-transitory machine-readable storage medium of claim 1, wherein the instructions upon execution cause the system to:
identify the language-neutral phrases of the source content based on use of a heuristic rule that specifies that a phrase having a specified characteristic is likely a language-neutral phrase.

8. The non-transitory machine-readable storage medium of claim 1, wherein the instructions upon execution cause the system to:
receive a user designation of the language-neutral phrases as language-neutral.

9. The non-transitory machine-readable storage medium of claim 1, wherein the received language-neutral phrases of the source content are for a first context, and the language-neutral translation memory is for the first context, and wherein the instructions upon execution cause the system to further:
for a second context that is different from the first context, receive different language-neutral phrases of a further source content; and
store the different language-neutral phrases in a second language-neutral translation memory for the second context.

10. A system comprising:
a processor; and
a non-transitory storage medium storing instructions that are executable on the processor to:
receive language-neutral phrases of a source content, wherein each language-neutral phrase is a phrase that is likely not to be translated during translation between different languages; and
store the language-neutral phrases in a language-neutral translation memory useable to determine a language-neutral target text in a document being translated between the different languages,
wherein the instructions are executable to perform the receiving of the language-neutral phrases and the storing of the language-neutral phrases in the language-neutral translation memory prior to a processing by a translation management system (TMS) that translates input text of documents between the different languages using translation memories including the language-neutral translation memory.

11. The system of claim 10, wherein the language-neutral translation memory includes translation segments each mapping between a respective one of the language-neutral phrases in a first language and a corresponding target text in a second language.

12. The system of claim 11, wherein the respective one of the identified language-neutral phrases in the first language is identical to the corresponding target text in the second language.

13. The system of claim 10, wherein the instructions are executable on the processor to further:
receive a first document for translation; and
in response to matching a given phrase of the first document to a first of the identified language-neutral phrases in the language-neutral translation memory, identify, using the TMS, a translation segment from the language-neutral translation memory and corresponding to the first identified language-neutral phrase for potential inclusion in a translated version of the first document

14. A method executed by a system comprising a processor, the method comprising:
pre-process source content to produce a language-neutral translation memory prior to use by a translation management system (TMS) in translating documents between different languages, the pre-processing comprising:
receiving language-neutral phrases of a source content; and
storing the language-neutral segments in the language-neutral translation memory useable to determine a language-neutral target text in a document being translated from a first language to a different second language.

15. The method of claim 14, further comprising identifying the language-neutral phrases of the source content based on applying a rule that specifies that an element having a specified characteristic is likely a language-neutral segment.
